(19) United States
(12) Patent Application Publication
(10) Pub. No.: US 2026/0154331 A1
(43) Pub. Date: Jun. 4, 2026

(54) METHOD AND SYSTEM FOR SEARCHING CONTENT SCENES

(71) Applicant: NAVER WEBTOON Ltd., Seongnam-si (KR)

(72) Inventors: Do Hyun KIM, Seongnam-si (KR); Kwang Ho LEE, Seongnam-si (KR); Ji Yeoun KWUN, Seongnam-si (KR); Se Ho KIM, Seongnam-si (KR)

(21) Appl. No.: 19/406,367

(22) Filed: Dec. 2, 2025

(30) Foreign Application Priority Data
Dec. 3, 2024 (KR) 10-2024-0177684

(51) Int. Cl. G06F 16/56; G06F 16/54; G06T 7/11; G06T 7/13; G06T 7/70; G06V 40/16

(52) U.S. Cl. CPC G06F 16/56; G06F 16/54; G06T 7/11; G06T 7/13; G06T 7/70; G06V 40/164

(57) ABSTRACT

A method of searching a content scene includes receiving an image file of content; dividing the image file into scene units to generate scene images, and storing the scene images in a first database; extracting vector data of the scene images by using an embedding model, and storing the vector data in a second database; receiving a query for an image search by using a search tool, and converting the query into a vector to detect data having high similarity from the vector data of the second database; and extracting a scene image corresponding to the data having high similarity among the scene images from the first database, and providing the scene image as a search result of the search tool.

### CROSS REFERENCE TO RELATED APPLICATIONS

The present application claims priority to Korean Patent Application No. 10-2024-0177684, filed Dec. 3, 2024, the entire contents of which are hereby incorporated by reference in their entirety.

### BACKGROUND OF THE INVENTION

### Field of the Invention

The present invention relates to a method of searching scenes of content and a system for supporting the same.

### Description of the Related Art

With advancements in technology, digital devices are becoming increasingly utilized. In particular, an electronic device (e.g., smartphone, tablet PC, etc.) is equipped with various functions including communication functions such as phone calls or text messages, as well as web surfing, music playback, and image viewing using the Internet.

With the popularization of electronic devices, unlike conventional traditional contents consumption media, the consumption of contents provided through electronic devices such as PCs, mobile devices, or the like is rapidly increasing, and webcomics is an example. Such webcomics are comics that are published in installments or serialized and distributed through the internet communication network. Webcomics are also referred to as webtoons.

As the consumption of contents steadily increases, research is being conducted on a method capable of efficiently producing and managing such contents. Korean Published Patent No. 10-2024-0148072 discloses a system for providing a webcomic production management service, and discloses an environment of producing a webcomic image by inserting and disposing characters, background, and text.

Due to characteristics of having contents composed of a large number of scenes and being serialized online, webcomics are not just simple images but are composed of scene images reflecting a story, the character's emotions, and story directing intention. Such scene images are frequently utilized in a process of working on or creating contents, and are also used in marketing design tasks.

However, a conventional process of searching for specific content during content creation or editing is inefficient. In most cases, a person checks for contents while searching for necessary scene images, which causes problems of excessive time and labor being consumed.

Accordingly, there is a need for a service specialized in content searching on scene units so that contents may be more efficiently produced.

### SUMMARY OF THE INVENTION

The present invention relates to a method of searching scenes of content in scene units and a system for supporting the same.

More specifically, the present invention relates to a method and a system for providing a content scene search service for constructing a database by processing content into scene units and providing an image-based or text-based search service by using the database.

Further, the present invention relates to a method and a system for providing a content scene search service based on meanings included in a user query.

Further, the present invention relates to a method and a system for providing a content scene search service capable of searching and providing a scene image that matches a condition desired by a user.

According to the present invention, the method may include receiving an image file of content; dividing the image file into scene units to generate scene images, and storing the scene images in a first database; extracting vector data of the scene images by using an embedding model, and storing the vector data in a second database; receiving a query for an image search by using a search tool, and converting the query into a vector to detect data having high similarity from the vector data of the second database; and extracting a scene image corresponding to the data having high similarity among the scene images from the first database, and providing the scene image as a search result of the search tool.

Further, there is provided a system for providing a content scene search, according to the present invention. The system may include a first database configured to store scene images obtained by dividing an image file of content into scene units; a data processing unit configured to extract vector data of the scene images by using an embedding model; and a second database configured to store the vector data, in which the second database may receive a query for an image search from a search tool of a user terminal, and convert the query into a vector to detect data having high similarity from the vector data, and the first database may extract a scene image corresponding to the data having high similarity among the scene images, and provide the same as a search result of the search tool.

Further, there is provided a program stored in a computer-readable recording medium, executed by one or more processes in an electronic device, according to the present invention. The program may comprise instructions to perform: receiving an image file of content; dividing the image file into scene units to generate scene images, and storing the scene images in a first database; extracting vector data of the scene images by using an embedding model, and storing the vector data in a second database; receiving a query for an image search by using a search tool, and converting the query into a vector to detect data having high similarity from the vector data of the second database; and extracting a scene image corresponding to the data having high similarity among the scene images from the first database, and providing the scene image as a search result of the search tool.

As described above, the method and the system for searching scenes of content according to the present invention may divide an image file of content into scene units, generate scene images, and store the scene images in a first database, thereby improving search performance by constructing a database using data required for providing a search service.

Further, the method and the system for searching scenes of content according to the present invention may extract vector data of the scene images by using an embedding model and store the vector data in a second database. Through this, the present invention enables semantic-based content scene search even for abstract user queries, and may provide the scene image required by the user accurately.

Further, the method and the system for searching scenes of content according to the present invention may receive a query for an image search by using a search tool, convert the query into a vector, detect data having high similarity from the vector data of the second database, and search and provide a scene image based on the query corresponding to an image or text.

Further, the method and the system for searching scenes of content according to the present invention may extract a scene image corresponding to data having high similarity among pre-stored scene images from the first database, and provide the same as a search result of the search tool. The user may conveniently find a scene image required in a task process of content creation, design, and marketing, and the present invention may improve the user's task efficiency.

### BRIEF DESCRIPTION OF THE DRAWINGS

FIG. 1 is a block diagram of a system for providing a content scene search service according to the present invention.

FIG. 2 is a block diagram of a data processing unit, a storage unit and a data storage unit according to the present invention.

FIG. 3 is a flowchart of a method of searching a content scene according to the present invention.

FIG. 4 is a conceptual view illustrating a database structure for storing scene images according to the present invention.

FIG. 5 is a conceptual diagram illustrating a scene-search service pipeline according to the present invention.

FIGS. 6A, 6B, 7A, and 7B are conceptual diagrams illustrating example user interface screens of the scene-search service according to the present invention.

FIG. 8 is a conceptual diagram illustrating a method of image search according to the present invention.

FIG. 9 is a conceptual diagram illustrating a method of searching scene images according to the present invention.

### DETAILED DESCRIPTION OF THE INVENTION

Hereinafter, exemplary embodiments disclosed in the present specification will be described in detail with reference to the accompanying drawings. The same or similar constituent elements are assigned with the same reference numerals regardless of reference numerals, and the repetitive description thereof will be omitted. The terms “module,” “unit,” “part,” and “portion” used to describe constituent elements in the following description are used together or interchangeably in order to facilitate the description. In addition, in the description of the exemplary embodiment disclosed in the present specification, the specific descriptions of publicly known related technologies will be omitted when it is determined that the specific descriptions may obscure the subject matter of the exemplary embodiment disclosed in the present specification. In addition, it should be interpreted that the accompanying drawings are provided only to allow those skilled in the art to easily understand the embodiments disclosed in the present specification, and the technical teachings disclosed in the present specification are not limited by the accompanying drawings, and includes all alterations, equivalents, and alternatives that are included in the teachings and the technical scope of the present invention.

The terms including ordinal numbers such as “first,” “second,” and the like may be used to describe various constituent elements, but the constituent elements are not limited by the terms. These terms are used only to distinguish one constituent element from another constituent element.

Singular expressions include plural expressions unless clearly described as different meanings in the context.

The present invention relates to a method of searching scenes of content and a system for providing a service using the same. The types of content to which the present invention may be applied may be very diverse. For example, at least one of contents such as webcomics, webnovels, music, electronic books (E-BOOK), videos, images, and the like may correspond to the content provided in the present invention.

Hereinafter, for convenience of description, the content corresponding to the webcomic will be described as an example. Here, a webcomic refers to a combination of “web” and “comics,” meaning cartoons or comics provided through an Internet communication network. Such content may be composed of a plurality of sub-content. A plurality of sub-content may make up a series of the content. Here, a series may refer to a continuous planned work or content. In the present invention, to avoid confusion between “content” and “sub-content,” the term “sub-content” will be referred to as “episode.”

In addition, one episode may include a plurality of scenes distinguished by boundaries of an image, or the like. For example, the episode may be composed of a plurality of layers such as speech balloon, leading line, tone, cut (or a panel (scene unit) of webcomic) border, and the like, and a scene may be defined through an edge included in the cut border layer.

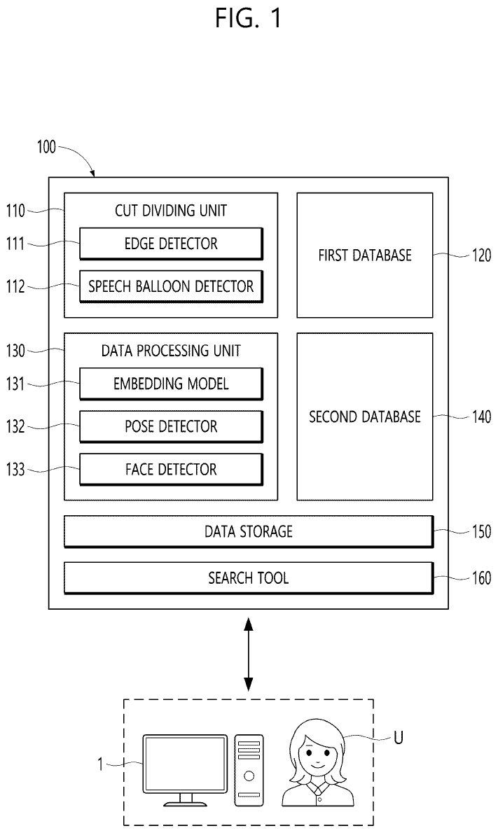

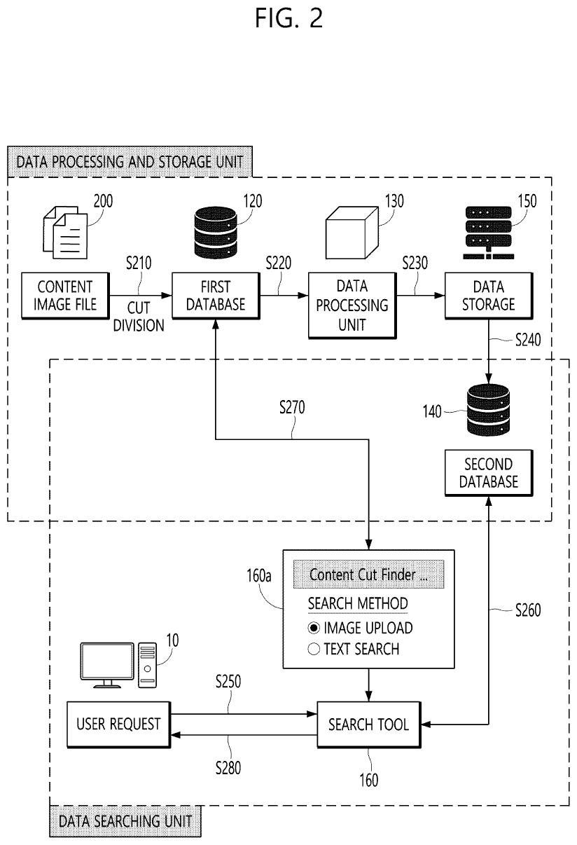

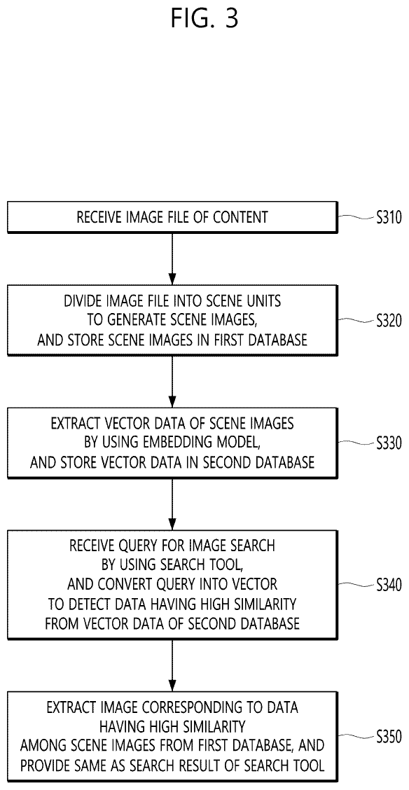

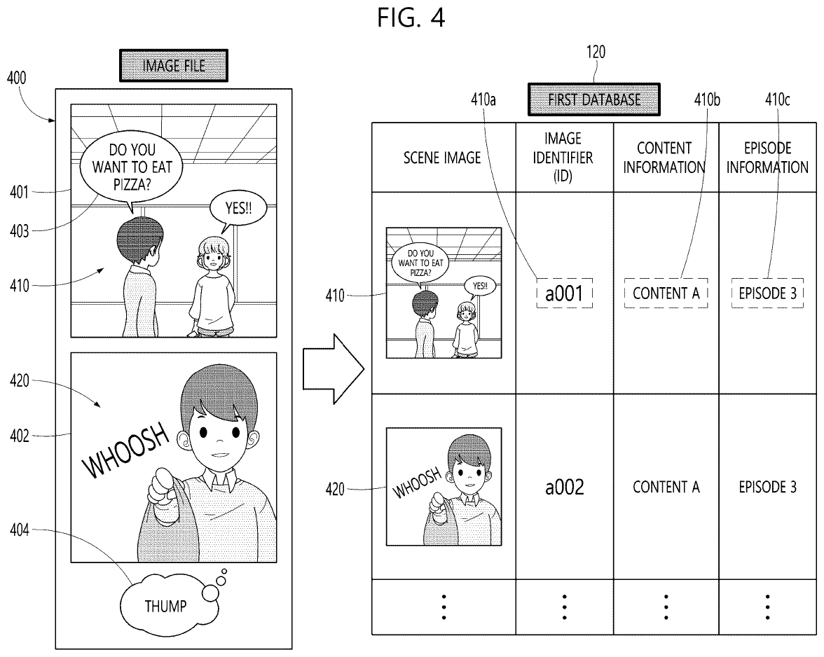

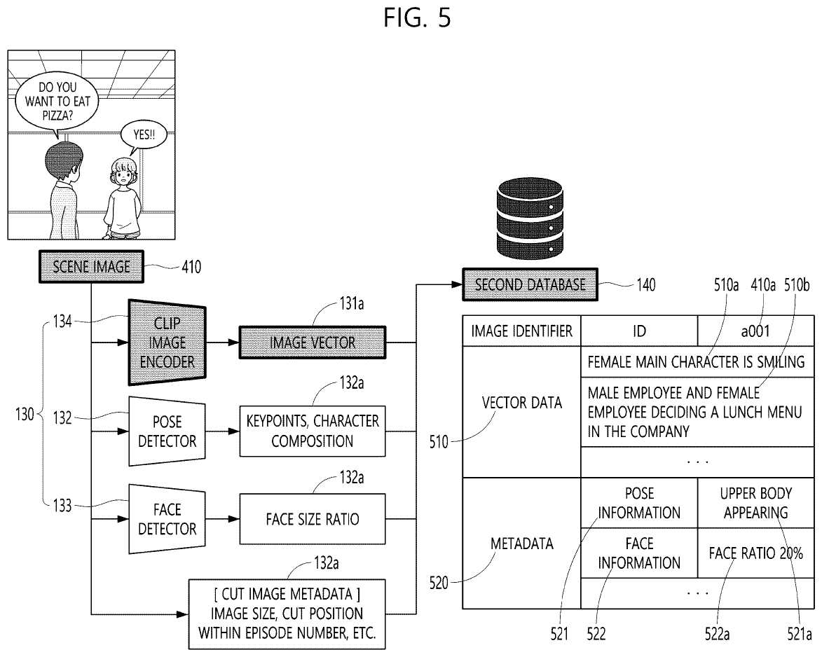

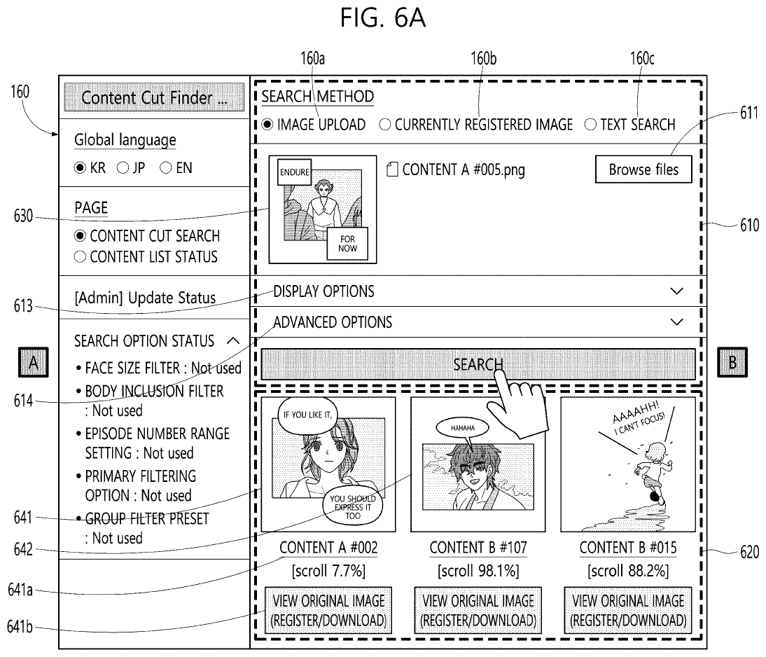

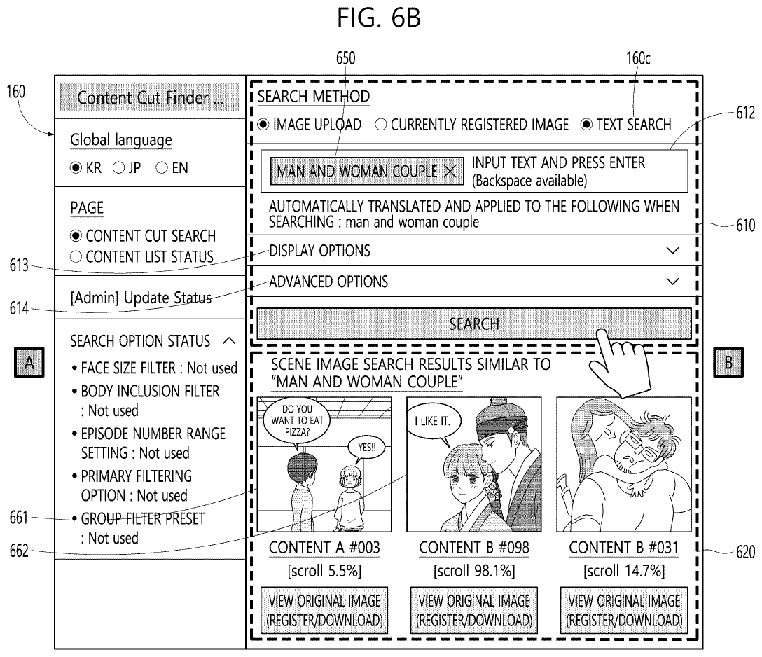

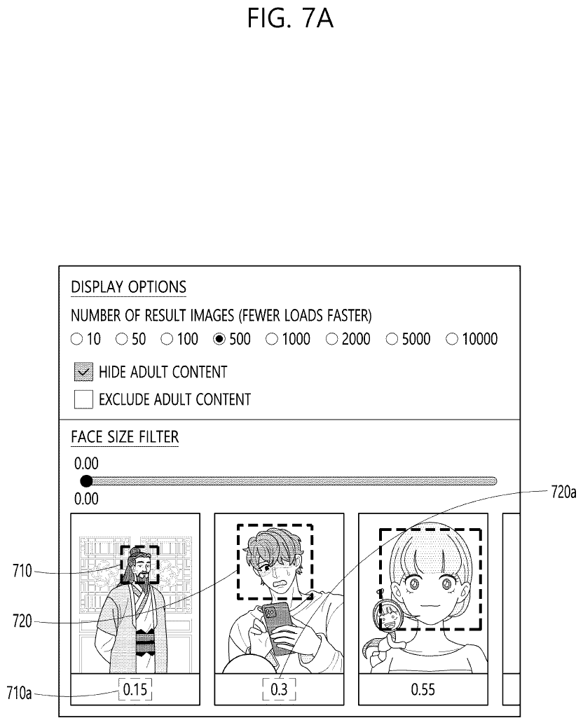

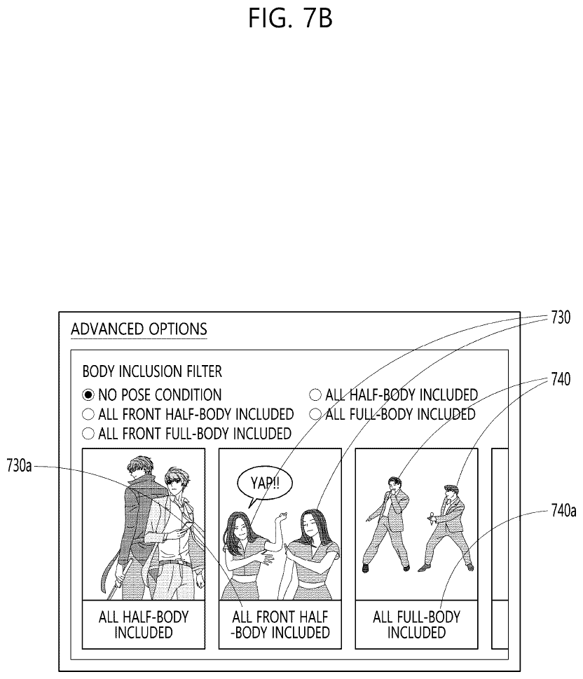

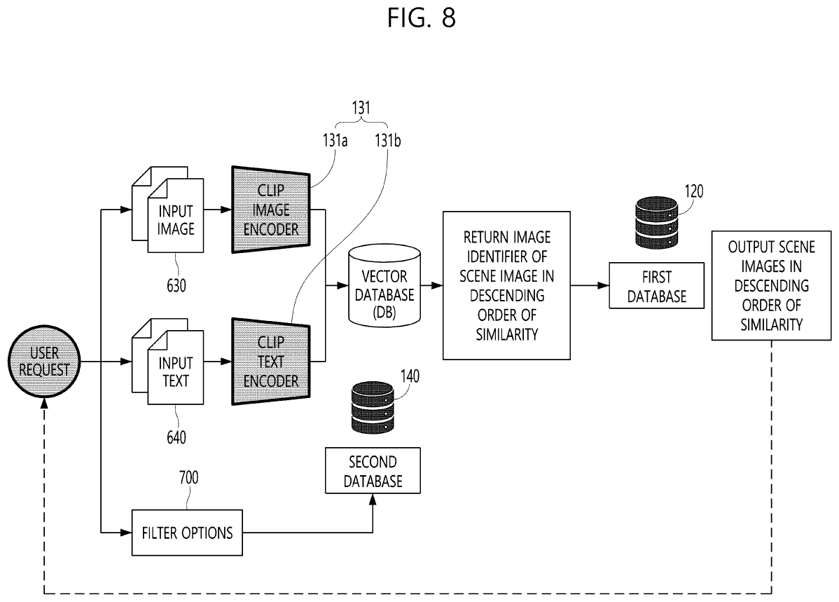

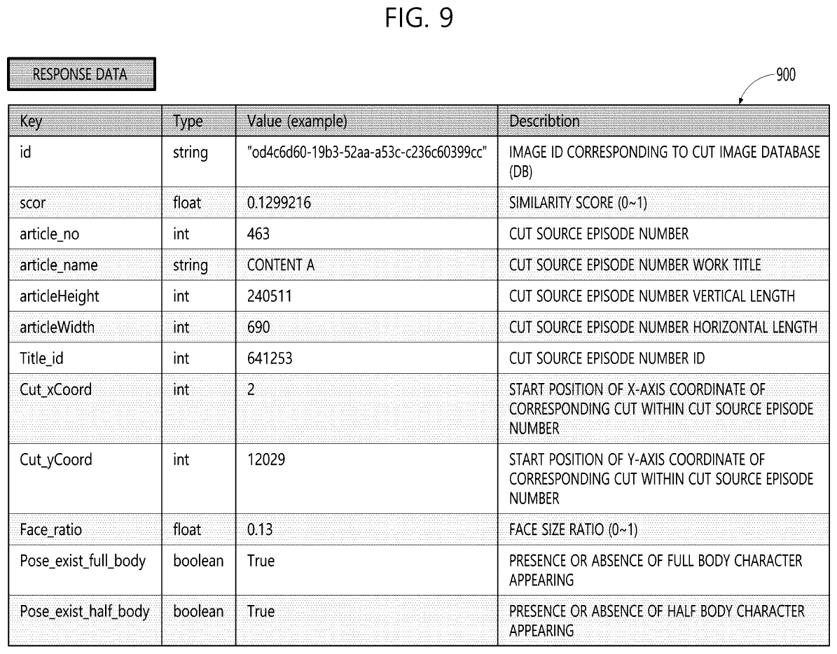

Hereinafter, with reference to the accompanying drawings, the content scene search service will be described in detail. FIG. 1 and FIG. 2 are diagrams for explaining a system for providing a content scene search service according to the present invention. FIG. 3 is a flowchart for explaining a method of searching a content scene according to the present invention, and FIG. 4, FIG. 5, FIG. 6A, FIG. 6B, FIG. 7, FIG. 8, and FIG. 9 are diagrams for explaining a method of searching and providing a content scene in the present invention.

As illustrated in FIG. 1, a system 100 for providing a content scene search service may include a cut dividing unit 110, a first database 120, a data processing unit 130, a second database 140, a data storage 150, and a search tool 160. As illustrated in FIG. 1, a system 100 for providing a content scene search service may include at least one of a cut dividing unit 110, a first database 120, a data processing unit 130, a second database 140, a data storage 150, and a search tool 160.

The system 100 may be implemented as a computer system or server system equipped with at least one hardware processor and one or more memory devices storing program instructions. The processor may execute the instructions to perform the functions attributed to the cut dividing unit 110, the data processing unit 130, the search tool 160, and other components described in the present specification. The system 100 may further include input/output interfaces and communication circuitry enabling the components to exchange data with each other and with an external user terminal.

The cut dividing unit 110 may divide the content with a method suitable for scene search in order to improve the scene search performance of the content. The cut dividing unit 110 may be implemented by one or more processors executing program instructions stored in at least one non-transitory computer-readable medium. The processors may include, for example, a central processing unit (CPU), a graphics processing unit (GPU), a digital signal processor (DSP), or an application-specific integrated circuit (ASIC). The memory may include ROM, RAM, flash memory, or other storage devices that store instructions for detecting edges, detecting speech balloons, and dividing the content into scene units. Accordingly, the cut dividing unit 110 may be embodied as a hardware module, a software module executed by the processor(s), or a combination thereof, and is not limited to any particular physical architecture.

In the present invention, the content may include a plurality of scenes, and an image file (manuscript or source data) of the content may include objects (e.g., background, floor, surrounding objects, character, speech balloon, text, edge, etc.) related to the plurality of scenes.

The cut dividing unit 110 may divide the image file of the content into scene units by using at least one of an edge detector 111 detecting edges of the scene units or a speech balloon detector 112 detecting a speech balloon, and may generate a plurality of scene images. The edge detector 111 and the speech balloon detector 112 may be dedicated portions of the cut dividing unit 110 for performing their respective functions, or they may be representations of different functions performed by the overall cut dividing unit 110

In the scene image, at least one of the objects included in the image file of the content may be included. In the present invention, the scene image may be used as a basic unit to provide a content scene search service.

That is, in the present invention, the cut dividing unit 110 may divide an image file of content into a basic unit for providing a search service.

In the first database 120, a plurality of scene images generated in the cut dividing unit 110 may be stored (S210, see FIG. 2). In the present invention, the first database 120 may also be referred to as a “source data storage.”

In the present invention, an image identifier (e.g., image ID) may be assigned to each of the scene images, and the first database 120 may store the scene images and the image identifiers matched with each other.

The first database 120 may provide a scene image corresponding to a content scene search of a user based on the image identifier.

The data processing unit 130 may generate information necessary for providing a search service from the plurality of scene images stored in the first database (S220, see FIG. 2). The data processing unit 130 may include at least one hardware processor configured to execute computer program instructions stored in at least one non-transitory computer-readable medium. The data processing unit 130 may further include memory elements, such as ROM, RAM, flash memory, or other storage devices, and communication interfaces enabling data exchange with other components. Accordingly, the functions attributed to the data processing unit 130 in this specification are realized by the execution of such instructions by the processor(s).

The data processing unit 130 may include at least one of an embedding model 131, a pose detector 132, or a face detector 133. These components may be dedicated portions of the data processing unit 130 for performing their respective functions, or they may be representations of different functions performed by the overall data processing unit 130.

The data processing unit 130 may extract vector data of the scene images by using the embedding model 131.

In the present invention, the embedding model 131 may be a Contrastive Language-Image Pre-Training (CLIP) model capable of processing images and texts respectively.

The data processing unit 130 may extract vector data from the scene images by using an image encoder of the CLIP embedding model 131 so that semantic-based search may be possible.

The data processing unit 130 may extract pose information of the scene images by using the pose detector 132, and may extract face information of the scene images by using the face detector 133.

Here, the term “pose information” may be understood as information related to a pose (position, disposition, direction arrangement, composition, layout, etc.) of an object included in the scene image. For example, the pose information may include information about whether and to what degree the body of a character is included (e.g., full body, upper body, lower body, etc.), whether the character is facing forward, and a posture of the character (e.g., “pose in which the character raises an arm,” “pose in which the character is sitting”). In addition, the pose information may include pose information of various objects included in the scene image, and, for example, may include “a structure in which a desk is placed in front of a red wall (disposition of object),” “a scenery unfolded on the top of a mountain (background composition),” “letters spread from left to right (text disposition),” and the like.

The “face information” may be information about a face of a character, and may include face size (e.g., a size or ratio occupied by a face area in a scene image, a ratio relative to a horizontal axis, etc.), face angle (e.g., front face, side face, 45-degree angle, face facing downward, face facing upward), and facial expression (e.g., smiling face (expression with mouth corners raised and bright eyes), angry face (expression with forehead wrinkled and lips tightly closed), tired face (state with eyes half-closed and without vitality)), gender and age of the character corresponding to the face, and the like.

The second database may perform a vector-based similarity search, and may also be referred to as a “vector search database (DB)” or a “vector database (DB).”

In the second database 140, at least one of vector data or metadata (pose information, face information) generated in the data processing unit 130 may be stored.

Further, in the second database 140, the vector data (which may include the metadata) and an image identifier of a scene image corresponding to the vector data may be stored matched with each other.

The second database 140 may convert a user query for image search into a vector, may detect vector data having high similarity with the converted query vector, and may provide the image identifier.

The second database 140 may use an optimization algorithm for vector-based similarity search, and may rapidly perform the search for massive scene images within a short time.

In the present invention, the vector data and the metadata may be stored once more separately in a data storage 150.

The data storage 150 may be understood as a backup database (DB) for responding to damage of the second database 140.

In the present invention, the vector data generated in the data processing unit 130 may be stored together with the metadata in the data storage 150 (S230, see FIG. 2). Further, the vector data and the metadata may be transmitted to the second database 140 so that the vector data and the metadata may be stored in the second database (S240, see FIG. 2).

The search tool 160 may be a user interface for providing a content scene search service, and may receive a user query for image search (S250, see FIG. 2). The search tool 160 may provide a scene image corresponding to the user query as a search result to the user based on the first database 120 and the second database.

The search tool 160 may receive, as the user query, at least one of an image or a text. Further, the search tool 160 may further receive, as a filter condition, an important element in scene image search (selection).

The filter conditions may vary. The filter conditions may be related to at least one of a pose or a face of a character in a scene image. In addition, the filter conditions may be related to at least one of a genre, an author, a work (specific content), or a sensitive photo blind processing.

The search tool 160 may vectorize the user query into a vector. The search tool 160 may request the second database to search for a scene image similar to the query vector based on the query vector and a filter value corresponding to the filter condition, and may receive the image identifier of a similar scene image from the second database 140 (S260, see FIG. 2).

The search tool 160 may extract, based on the image identifier received from the second database 140, a scene image corresponding to the user query from the first database 120 (S270, see FIG. 2). Further, the search tool 160 may provide, as the search result of the user query, the scene image extracted from the first database 120 (S280, see FIG. 2).

Further, the present invention may be configured to transmit and receive various information related to providing the content search service through wired or wireless communication. Transmission and reception of such information may be performed by a communication unit (or communication module) included in the above-described configurations (110 to 160). In addition, the present invention may perform communication with an external server or a user terminal 1 through a separate communication unit.

The present invention may construct a database for vector search using a scene image as a basic unit. Further, by using the database, the scene image desired by the user may be searched and provided. In particular, the present invention may provide a search service for an abstract user request (e.g., “a woman with long red hair,” “a gloomy street atmosphere”) through vectorization of the scene image utilizing the embedding model 131, not simply classifying the scene image (e.g., classifying based on predefined tags (e.g., long hair, face appearing)).

Hereinafter, based on the above-described configurations, a method of effectively searching and providing a scene image even for an abstract user query will be described.

In the present invention, a process of receiving an image file of content may be performed (S310, see FIG. 3).

In the present invention, in order to provide a content scene search service, an image file of the content may be received (or collected). In the present invention, the image file of the content may be received from an external server (e.g., a content management server in which the image file of the content is registered), or may be received from a user terminal 1 of a user (e.g., author) who generated the image file of the content.

In the present invention, the image file may be divided into scene units to generate scene images, and a process of storing the scene images in a first database may be performed (S320, see FIG. 3).

The cut dividing unit 110 may distinguish a plurality of scenes in the image file of the content and may generate a scene image corresponding to each of the plurality of scenes.

As described above, in the present invention, the content includes the plurality of scenes, and the image file (manuscript or source data) of the content may include objects (e.g., background, floor, surrounding objects, character, speech balloon, text, edge, etc.) related to the plurality of scenes.

As illustrated in FIG. 4, the cut dividing unit 110 may detect edges 401 and 402 and speech balloons 403 and 404 of the scenes in the image file 400 by using at least one of an edge detector 111 or a speech balloon detector 112, and may divide the image file 400 into a plurality of scene images 410 and 420. More specifically, the cut dividing unit 110 may divide the image file 400 based on the edges 401 and 402 detected in the image file 400, and may generate the plurality of scene images 410 and 420.

The cut dividing unit 110, in order to improve the performance of the embedding model 131 extracting vector data from the scene image, may generate the scene image by excluding a speech balloon extending beyond the edge of the scene.

For example, in FIG. 4, a first speech balloon 403 (“Do you want to eat pizza?”) does not extend beyond a first edge 401, and the cut dividing unit 110 may generate a first scene image 410 including the first speech balloon 403. On the other hand, a second speech balloon 404 (“Thump”) is positioned beyond a second edge 402, and the cut dividing unit 110 may generate a second scene image 420 by excluding the second speech balloon 404.

That is, the cut dividing unit 110 may use the edges 401 and 402 detected in the image file 400, may extract an area specified by the edges 401 and 402 in the image file 400, and may generate the scene images 410 and 420.

As illustrated in FIG. 4, the plurality of scene images 410 and 420 generated in the cut dividing unit 110 may be stored in the first database 120.

An image identifier (e.g., “a001” 410a) identifying the scene image may be assigned to the scene images 410 and 420 stored in the first database 120. In the first database 120, the scene image 410, the image identifier 410a assigned to the scene image 410, content information 410b to which the scene image 410 belongs, and episode information 410c of the content (e.g., episode number information) may be stored matched with each other.

The first database 120 may return (or provide) a scene image corresponding to data having high similarity with a user query of the search tool 160 as a search result based on the image identifier 410a.

That is, the scene image stored in the first database 120 may be used in the search tool 160 to provide an actual original image (the image file of the content or the scene image) for the search result.

In the present invention, a process of extracting vector data of the scene images by using the embedding model 131 and storing the vector data in the second database 140 may be performed (S330, see FIG. 3).

The data processing unit 130 may analyze the plurality of scene images 410 and 420 stored in the first database 120 in order to provide a search service, and may generate data necessary for the search service.

As described above, the data processing unit 130 may include the embedding model 131, the pose detector 132, and the face detector 133.

As illustrated in FIG. 5, the data processing unit 130 may extract vector data 131a of the scene image 410 by using the embedding model 131.

In the present invention, the embedding model 131 may be a Contrastive Language-Image Pre-Training (CLIP) model capable of processing images and texts respectively. In the present invention, the same reference numeral “131” will be assigned also to the CLIP model for explanation.

The CLIP embedding model 131 may be capable of processing images and texts simultaneously. More specifically, the CLIP embedding model 131 may include an image embedding model and a text embedding model, and the image embedding model and the text embedding model may be trained to share the same vector space. Such CLIP embedding model 131 may measure (determine or calculate) similarity between images and texts.

The data processing unit 130, by using the CLIP embedding model 131, may generate vector data including visual features of the scene image 410 (e.g., “blue sky,” “man and woman”) and abstract meanings of the scene (e.g., “female main character is smiling,” “a male employee and a female employee deciding lunch menu in a company”).

That is, the data processing unit 130, so that semantic-based search may be possible, may generate a vector image corresponding to the scene image 410 by comprehensively considering the objects, the texts, and the semantic context included in the scene image 410.

Further, the data processing unit 130 may extract metadata of the scene image 410 by using at least one of the pose detector 132 or the face detector 133.

The data processing unit 130 may extract pose information (e.g., key points, character composition 132a) as the metadata from the scene image 410 by using the pose detector 132, and may extract face information (e.g., face size, ratio, etc. 132a) as the metadata from the scene image 410 by using the face detector 133.

As described above, the term “pose information” may be understood as information related to a pose (position, disposition, directional arrangement, composition, layout, etc.) of an object included in the scene image. For example, the pose information may include information about whether and to what degree the body of a character is included (e.g., full body, upper body, lower body, etc.), whether the character is facing forward, and the posture of the character (e.g., “pose in which the character raises an arm,” “pose in which the character is sitting”). In addition, the pose information may include pose information of various objects included in the scene image, and, for example, may include “a structure in which a desk is placed in front of a red wall (disposition of object),” “a scenery unfolded on the top of a mountain (background composition),” “letters spread from left to right (text disposition),” and the like.

The “face information” may be information about a face of a character, and may include face size (e.g., a size or ratio occupied by a face area in a scene image, a ratio relative to a horizontal axis, etc.), face angle (e.g., front face, side face, 45-degree angle, face facing downward, face facing upward), and facial expression (e.g., smiling face (expression with mouth corners raised and bright eyes), angry face (expression with forehead wrinkled and lips tightly closed), tired face (state with eyes half-closed and without vitality)), gender and age of the character corresponding to the face, and the like.

The data processing unit 130 may extract various metadata required for scene image search from the scene image 410. For example, the data processing unit 130 may extract various metadata 134a such as the size information of the scene image, the position information of the scene image 410 in the image file 400, the genre information of the content to which the scene image 410 belongs, and the like.

The vector data generated in the data processing unit 130 may be stored in the second database 140. The pose information and the face information generated in the data processing unit 130 may be stored in the second database 140 as metadata together with the vector data.

As illustrated in FIG. 5, in the second database 140, for each scene image, the image identifier 410a of the scene image, the vector data 510, and the metadata 520 may be stored matched with each other. The vector data 510 stored in the second database 140 may include visual features and semantic features of the scene image (e.g., “female main character is smiling” 510a, “male employee and female employee deciding a lunch menu in the company”510b), and the second database 140 may provide the scene image even for an abstract user query by using the vector data. As illustrated in FIG. 5, in the second database 140, for each scene image, the image identifier 410a of the scene image, the vector data 510, and the metadata 520 may be stored in association with one another. The vector data 510 stored in the second database 140 may include visual features and semantic features of the scene image (e.g., “female main character is smiling,” 510a; “male employee and female employee deciding a lunch menu in the company,” 510a, 510b).

Although the second database 140 stores such information, a search for a scene image corresponding to even an abstract user query may be performed by a processor or a search engine included in the data processing unit 130, which accesses the second database 140, compares the vector data 510 with features derived from the user query, and retrieves the scene image(s) having the highest similarity or relevance. Accordingly, the second database 140 functions as a storage repository, while the actual retrieval and matching operations are carried out by the data processing unit 130 using the stored vector data.

The metadata 520 in the second database 140 may include at least one of the pose information 521 or the face information 522 of the scene image, and the second database 140 may search and provide the scene image corresponding to various filter conditions (e.g., “upper body appearing” 521a, “face ratio 20%” 522 a) by using the metadata 520.

The second database 140 may calculate similarity between the vector data 510 and a query vector corresponding to a user query, and may provide (return) the image identifier of the scene image based on the similarity. The second database 140 stores the vector data 510 for each scene image. A similarity calculation between the vector data 510 and a query vector derived from a user query is performed not by the database itself but by a processor or similarity computation module included in the data processing unit 130. The processor may load the vector data 510 from the second database 140, compute similarity metrics (e.g., cosine similarity or distance-based measures) with the query vector, and determine the scene image having the highest similarity. The data processing unit 130 may then provide (return) the image identifier of the corresponding scene image based on the computed similarity.

In the present invention, a process of receiving a query for an image search by using a search tool, converting the query into a vector, and detecting data having high similarity from the vector data of the second database may be performed (S340, see FIG. 3). Further, in the present invention, a process of extracting an image corresponding to data having high similarity among the scene images from the first database and providing the same as a search result of the search tool may be performed (S350, see FIG. 3).

The search tool 160 may be executed in the user terminal 1. The search tool 160 may be installed in the user terminal 1 based on a user selection. The user may download and install the search tool 160 in the user terminal 1 through a system provided in the present invention. In addition, the search tool 160 may be accessed through a web browser installed in the user terminal 1. In this case, the search tool 160 may be provided as a service page displayed on the display screen of the user terminal 1.

As illustrated in FIGS. 6A and 6B, the search tool 160 may include a first area 610 for inputting search information and a second area 620 for outputting a scene image corresponding to data having high similarity with the search information.

The first area 610 may include at least one of a first input window 611 (in FIG. 6A) or 612 (in FIG. 6B) for receiving a query among the search information or a second input window 613 (in FIG. 6A) or 614 (in FIG. 6B) for receiving a filter condition.

The first input window 611 or 612 may receive an image 630 corresponding to the query (see FIG. 6A) or a text 650 (see FIG. 6B). The first input window 611 or 612 may receive an image 630 corresponding to the user query (see FIG. 6A) or a text 650 (see FIG. 6B). In FIG. 6A, although the image 630 is displayed outside the boundary of the input window 611, the image 630 is an example of an image that has been selected or uploaded through the input window 611. The illustration simply shows the image 630 after being added to the system, and does not limit the positional or visual arrangement of the uploaded image relative to the input window 611.

The image query 630 may be uploaded and input from the user terminal 1. The search tool 160 may provide a reference image, and one of the reference images may be specified as the image query 630. As illustrated in FIG. 6A, in the first area 610, an area for selecting an input method of the user query may be included, and when the area corresponding to an image upload input method (“IMAGE UPLOAD”) 160a is selected, the search tool 160 may provide the first input window 611 so that an image may be uploaded. When the area corresponding to a reference image input method (“CURRENTLY REGISTERED IMAGE”) 160b is selected, the search tool 160 may provide an input window so that one of at least one reference image registered in the search tool 160 may be selected.

The text query 650 may include a natural language text describing a scene that the user wishes to find. In the present invention, the text query 650 may include abstract contents (e.g., “a woman with long red hair,” “a gloomy street atmosphere”). As illustrated in FIG. 6B, when the area corresponding to a text input method (“TEXT SEARCH”) 160c is selected, the search tool 160 may provide the first input window 612 so that the query text 650 may be input.

Further, the search tool 160 may receive both an image query and a text query. In this case, the search tool 160 may search and provide the scene image by using both the image query and the text query.

The second input window 613 or 614 may receive various filter conditions for the scene image search. The filter condition may be related to at least one of the pose or the face of a character in a scene image.

As illustrated in FIG. 7A, the search tool 160 may receive a filter condition for face size. For example, the search tool 160 may receive, as the filter condition, the size information (e.g., 710a, 720a) of face images 710 and 720 in the scene image.

Further, as illustrated in FIG. 7B, the search tool 160 may receive a filter condition of a character pose. For example, the search tool 160 may receive, as the filter condition, information 730a and 740a including the body (e.g., upper body, full body) and the pose (e.g., front, rear) of characters 730 and 740 included in the scene image.

As illustrated in FIG. 8, the search tool 160 may convert the queries 630 and 640 for the image search into vectors. The search tool 160 may convert the image query 630 into a vector by using an image encoder 131a of the CLIP embedding model 131 and may convert the text query 640 into a vector by using a text encoder 131b of the CLIP embedding model so that semantic-based search may be possible. When both the image query 630 and the text query 640 are input, the search tool 160 may convert both the image query 630 and the text query 640 into vectors.

The search tool 160 may transmit a query vector together with filter information 700 to the second database 140 to request a search.

Vectorization of the query may also be performed in the second database 140. In this case, the second database 140 may receive a query for the image search from the search tool of the user terminal 1 and may convert the received query into a vector. Since the method of converting the query into a vector is the same as that of the search tool 160, detailed description thereof will be omitted. Hereinafter, it will be described without distinguishing whether the vectorization of the query is performed in the second database 140 or the search tool 160. Vectorization of the query may be handled in connection with the second database 140. In practice, the conversion of a received query into a vector is performed not by the second database 140 itself, but by a processor or a vectorization module included in the data processing unit 130 or the search tool 160. The processor may access the second database 140 to obtain necessary reference data or model parameters, and then execute program instructions for converting the received query into a vector by applying the same vectorization technique used in the search tool 160. Accordingly, the second database 140 functions as a storage repository for vector data and model parameters, while the actual conversion into a vector is carried out by the processor. Hereinafter, for simplicity of explanation, the description will not distinguish whether the processor performing the vectorization is associated with the second database 140 or the search tool 160.

The second database 140 may return to the search tool 160 the image identifiers of the scene images in descending order of similarity by using the query vector and the filter information.

The second database 140 may calculate the similarity between the query vector and vector data of the scene images. For example, the second database 140 may calculate similarity between the query vector and each of the plurality of vector data based on Cosine Similarity. The second database 140 may provide to the search tool 160 the image identifiers of the scene images in descending order of similarity.

In this case, the second database 140 may provide to the search tool 160 the image identifiers of the scene images having the metadata corresponding to the filter condition.

The second database 140 may primarily specify the scene images corresponding to the filter condition. Further, the second database 140 may calculate similarity between each of the vector data of the specified scene images and a query vector, and may return to the search tool 160 the image identifiers in descending order of similarity with the query while corresponding to the filter condition.

Further, when both an image and a text are included in the query (case where the user searches for a desired image by using both the image and the text), the second database 140 may specify the scene images having high similarity with one of the image and the text, and may return the image identifiers of the scene images having high similarity with the other among the specified scene images.

For example, the second database 140 may, in a first step, calculate similarity between the text query and the scene images. The second database 140 may calculate similarity between the image query and the scene images having high similarity with the text query by as much as a preset number (or preset ratio). Further, the second database 140 may return the image identifiers of the scene images in descending order of similarity with the image query among the specified scene images.

Further, as illustrated in FIG. 9, the second database 140, in response to a search request of the search tool 160, may provide response data 900 for the scene images having high similarity with the query. The response data 900 may include at least some of an image identifier of a scene image having high similarity with the query, a similarity score, content information (e.g., title of work) to which the scene image belongs, episode information of the content (e.g., episode number information), position information of the scene image in the content image file (e.g., coordinate information where the scene image starts), and metadata (e.g., face size ratio information, presence or absence of full body character appearing, presence or absence of upper body appearing, etc.).

The search tool 160 may detect a scene image from the first database 120 by using the image identifier returned from the second database 140. The search tool 160 may transmit the image identifier returned from the second database 140 to the first database 120 and may request the scene image corresponding to the image identifier.

The first database 120, in response to the request of the search tool 160, may return to the search tool 160 the scene image corresponding to the image identifier among the plurality of scene images. That is, the first database 120 may extract the scene image corresponding to data having high similarity with the query input by the user among the scene images, and may provide the same as a search result of the search tool 160.

In the second area 620 of the search tool 160, the scene images may be output as a search result of the query. In this case, the search tool 160 may output the scene images 641, 642, 661, and 662 in the second area 620 in descending order of similarity with the queries 630 and 650.

As illustrated in FIG. 6A, the search tool 160 may output the scene images in descending order of similarity along a first direction A to a second direction B. The search tool 160 may output the scene image 641 having the highest similarity with the image query 630, and may output, in the second direction B of the scene image 641, the scene image 642 having the second highest similarity. As illustrated in FIG. 6B, the search tool 160 may output the scene image 661 having the highest similarity with the text query 650 in the first direction A, and may output the scene image 662 having the next highest similarity along the first direction A to the second direction B.

Further, the search tool 160 may display, in the second area 620, a thumbnail image of images of the scene units and episode information of the content to which the images of the scene units belong.

The search tool 160, as a search result, may provide at least some of a thumbnail of the scene images having high similarity with the queries 630 and 650, content information to which the scene images belong, episode information of the content to which the scene images belong, position information of the scene image in the episode, and an original image of the scene image.

As illustrated in FIG. 6A, the search tool 160 may output, in the second area 620, a specific scene image (or a thumbnail of the scene image 641) having high similarity with the query 630. Further, the search tool 160 may output, around the specific scene image (or the thumbnail 641), content information 641a of the specific scene image (e.g., content title or link associated with a content page), episode number information, and position information of the specific scene image in the episode (e.g., “scroll 7.7%”). The search tool 160 may further output, around the specific scene image (or the thumbnail 641), a graphic object 641b associated with providing (downloading) an original image of the specific scene image. The search tool 160 may provide the specific scene image stored in the first database 120 based on selection of the graphic object 641b.

As described above, the method and the system for searching scenes of content according to the present invention may divide an image file of content into scene units, generate scene images, and store the scene images in a first database, thereby improving search performance by constructing a database using data required for providing a search service.

Further, the method and the system for searching scenes of content according to the present invention may extract vector data of the scene images by using an embedding model and store the vector data in a second database. Through this, the present invention enables semantic-based content scene search even for abstract user queries, and may provide the scene image required by the user accurately.

Further, the method and the system for searching scenes of content according to the present invention may receive a query for an image search by using a search tool, convert the query into a vector, detect data having high similarity from the vector data of the second database, and search and provide a scene image based on the query corresponding to an image or text.

Further, the method and the system for searching scenes of content according to the present invention may extract a scene image corresponding to data having high similarity among pre-stored scene images from the first database, and provide the same as a search result of the search tool. The user may conveniently find a scene image required in a task process of content creation, design, and marketing, and the present invention may improve the user's task efficiency.

Further, the present invention described above may be implemented as computer-readable code or instructions on a medium in which a program is recorded. That is, the present invention may be provided in the form of a program.

A computer-readable medium includes all kinds of recording devices for storing data readable by a computer system. Examples of computer-readable media include hard disk drives (HDDs), solid state disks (SSDs), silicon disk drives (SDDs), ROMs, RAMs, CD-ROMs, magnetic tapes, floppy discs, optical data storage devices, and the like.

Further, the computer-readable medium may be a server or cloud storage that includes storage and that the electronic device is accessible through communication. In this case, a computer may download the program according to the present invention from the server or cloud storage, through wired or wireless communication.

Further, in the present invention, the computer described above is an electronic device equipped with a processor, that is, a central processing unit (CPU), and is not particularly limited to any type. In the present invention, the “computer” described above may be implemented by an electronic device including at least one hardware processor and at least one memory device. The processor, such as a central processing unit (CPU), a graphics processing unit (GPU), a digital signal processor (DSP), or an application-specific integrated circuit (ASIC), may execute program instructions stored in the memory. The memory may include non-transitory computer-readable media such as ROM, RAM, flash memory, or other storage devices storing instructions for performing the functions attributed to the data processing unit 130, the search tool 160, and other software modules described in the present specification. The computer may further include input/output interfaces and communication circuitry enabling data exchange with the user terminal 1, the first database 120, and the second database 140. Accordingly, the functions described herein are realized by execution of program instructions by such processor(s), and the term “computer” is not limited to any particular architecture or configuration. It should be appreciated that the detailed description is interpreted as being illustrative in every sense, not restrictive. The scope of the present invention should be determined on the basis of the reasonable interpretation of the appended claims, and all of the alterations within the equivalent scope of the present invention belong to the scope of the present invention.

What is claimed is:

1. A method of searching a content scene performed by at least one processor, comprising:
receiving an image file of content;
dividing the image file into scene units to generate scene images, and storing the scene images in a first database;
extracting vector data of the scene images by using an embedding model, and storing the vector data in a second database;
receiving a query for an image search by using a search tool, and converting the query into a vector to detect data having high similarity from the vector data of the second database; and
extracting a scene image corresponding to the data having high similarity among the scene images from the first database, and providing the scene image as a search result of the search tool.

2. The method of claim 1, wherein the scene image is generated by detecting edges and speech balloons of a scene in the image file by using a detector, and by excluding a speech balloon extending beyond the edges of the scene.

3. The method of claim 1, wherein an image identifier is assigned to the scene images stored in the first database, and the scene image corresponding to the data having high similarity is provided as the search result of the search tool based on the image identifier.

4. The method of claim 1, wherein the storing of the vector data in the second database comprises:
extracting the vector data from the scene images by using an image encoder of the embedding model so as to enable semantic-based search; and
extracting pose information by using a pose detector, and extracting face information by using a face detector.

5. The method of claim 4, wherein the embedding model is a Contrastive Language-Image Pre-Training (CLIP) model for processing images and texts.

6. The method of claim 4, wherein the pose information and the face information are stored as metadata together with the vector data in the second database.

7. The method of claim 1, further comprising:
storing the vector data together with metadata in a data storage, and transmitting the vector data and the metadata to the second database.

8. The method of claim 1, wherein the detecting of the data having high similarity comprises:
converting the query into a vector and requesting the second database to perform a search together with filter information; and
returning, from the second database, image identifiers of the scene images in descending order of similarity by using the vector and the filter information.

9. The method of claim 8, wherein the scene image is detected from the first database by using the image identifier, and is transmitted to a user terminal in which the search tool is executed.

10. The method of claim 1, wherein the search tool comprises:
a first area for inputting search information; and
a second area for outputting a scene image corresponding to data having high similarity, and
wherein the images of the scene units are output in the second area in descending order of similarity.

11. The method of claim 10, wherein the first area comprises:
a first input window for inputting an image or text corresponding to the query; and
a second input window for inputting a filter condition regarding at least one of a pose or a face of a character in the scene image.

12. The method of claim 10, wherein a thumbnail image of the images of the scene units and episode information of the content to which the images of the scene units belong are displayed in the second area.

13. A system for providing a content scene search, comprising:
a first database configured to store scene images obtained by dividing an image file of content into scene units;
a data processing unit configured to extract vector data of the scene images by using an embedding model; and
a second database configured to store the vector data,
wherein the second database receives a query for an image search from a search tool of a user terminal, and converts the query into a vector to detect data having high similarity from the vector data, and
wherein the first database extracts a scene image corresponding to the data having high similarity among the scene images, and provides the scene image as a search result of the search tool.

14. The system of claim 13, wherein the vector data is extracted from the scene images by using an image encoder of the embedding model, and
wherein the embedding model is a Contrastive Language-Image Pre-Training(CLIP) model capable of processing images and texts respectively.

15. A non-transitory computer-readable recording medium storing a program for enabling a computer to perform the steps comprising:
receiving an image file of content;
dividing the image file into scene units to generate scene images, and storing the scene images in a first database;
extracting vector data of the scene images by using an embedding model, and storing the vector data in a second database;
receiving a query for an image search by using a search tool, and converting the query into a vector to detect data having high similarity from the vector data of the second database; and
extracting a scene image corresponding to the data having high similarity among the scene images from the first database, and providing the scene image as a search result of the search tool.
